(19) United States
(12) Patent Application Publication
(10) Pub. No.: US 2008/0084522 A1
(43) Pub. Date: Apr. 10, 2008

(54) Liquid Crystal Device with Stratified Phase-separated Composite and Method for Forming the Same

(75) Inventors: Wei Lee, Tao-Yuan (TW); Yi-Sheng Lu, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 11/539,618

(22) Filed: Oct. 6, 2006

(51) Int. Cl. G02F 1/1333

(52) U.S. Cl. 349/88

(57) ABSTRACT

The present invention discloses a liquid crystal device comprising a first substrate covered with an alignment layer and a composite material, wherein the composite material is phase-separated by a first polymerization into a polymer layer and a liquid crystal layer, wherein the liquid crystal layer is disposed adjacent to the alignment layer, and the polymer layer is disposed adjacent to the liquid crystal layer. Furthermore, the liquid crystal layer comprises polymer formed in situ by a second polymerization. Additionally, the mentioned liquid crystal device can further comprise a second substrate located atop said polymer layer, wherein the second substrate is in planer contact with the polymer layer.

### BACKGROUND OF THE INVENTION

1. Field of the Invention

The present invention is generally related to liquid crystal device, and more particularly to liquid crystal device with stratified phase-separated composite and method for forming the same.

2. Description of the Prior Art

The structured binary material as a composite comprising liquid crystal (LC) and polymer holds great promise for optoelectronic applications in the area of liquid-crystal display (LCD) and flexible information display. By polymerization-induced isotropic or anisotropic phase separation from a homogeneous blend of a LC substance and a polymer precursor, the polymeric material provides mechanical support to the substrate(s), rendering the LC confined in a cell mechanically rugged, as such LC cells fabricated on flexible substrates become possible and even durable. Polymer-dispersed LC (PDLC) films, containing LC ranges from 30% to 70% by weight, which are heterogeneous systems consisting of dispersed or continuous LC phases in various matrices, have attracted much attention since their first introduction in the 1980s. In comparison with a PDLC, polymer-network LC (PNLC), containing higher LC content ranging from 70-90 wt %, requires a relatively lower driving voltage. A polymer-stabilized LC (PSLC), which is also known as a LC gel, contains LC of more than 90% or even 95% by weight and requires lowest operation voltage for display and light-control devices.

Recently, novel innovations involving the formation of controlled structures by means of photopolymerization-induced anisotropic phase separation have brought about the realization of in-situ reduction of the cell gap via the phase-separated composite film (PSCOF) technique as well as the improved stratification and stratified box array of crosslinked polymeric containers filled with a switchable LC phase based on the Paintable technology. Most recently, a plastic LCD with the pixel-isolated LC (PILC) mode has been demonstrated. In this structure, LC molecules are isolated in pixels defined by interpixel vertical polymer walls and horizontal polymer films on the upper substrate. Moreover, the microstructure can be produced by a stamping method.

The development of PSCOF technique is a true breakthrough; however, it meets some obstacles, as the LC layer is often contaminated with un-reacted monomer or oligomer greatly influencing a display property or long-time operation stability. In order to decrease the amount of residual prepolymer in the LC layer, conventional solution usually advises user of extending photo illumination, which is an energy costing and inefficient process.

### SUMMARY OF THE INVENTION

In view of the above background and to fulfill the requirements of industry, a new liquid crystal device with stratified phase-separated composite and method for forming the same are invented.

One subject of the present invention is to apply two-step photopolymerization process by opposite photo exposure. Comparing to the conventional PSCOF technique, residual monomer or oligomer in the liquid crystal layer is allowed to polymerize, forming a PDLC, PNLC, or PSLC underneath the hard polymer coating. This novel process not only provides opportunity to combine two different structures for their merits, but also provides a better way to solve the contamination problem. Therefore, the liquid crystal composite provided in this invention does have the economic advantages for industrial applications.

Another subject of the present invention is to take the advantages of a phase-separated composite film as well as a PDLC, PNLC or PSLC so that it can be applied to (flexible) display technology with fast response and reasonable mechanical stability.

Accordingly, the present invention discloses a liquid crystal device comprising a first substrate covered with an alignment layer and a composite material, wherein the composite material is phase-separated by a first polymerization into a polymer layer and a liquid crystal layer, wherein the liquid crystal layer is disposed adjacent to the alignment layer, and the polymer layer is disposed adjacent to the liquid crystal layer. Furthermore, the liquid crystal layer comprises polymer formed in situ by a second polymerization. Additionally, the mentioned liquid crystal device can further comprise a second substrate located atop said polymer layer, wherein the second substrate is in planer contact with the polymer layer.

### BRIEF DESCRIPTION OF THE DRAWINGS

FIG. 1 shows formation of a phase-separated composite film (PSCOF) for liquid crystal displays according to example 1 of the present invention;

FIG. 2 is schematic of the internal structure of a stratified polymer-stabilized liquid crystal (SPSLC) according to example 1 of the present invention;

FIG. 3 is the experimental setup of electro-optical measurement according to example 1 of the present invention;

FIG. 4 shows rise time as a function of voltage according to example 1 of the present invention, wherein SPSLC (□) and PSCOF (); and

FIG. 5 shows voltage-dependent decay time according to example 1 of the present invention, wherein SPSLC (□) and PSCOF ()

### DESCRIPTION OF THE PREFERRED EMBODIMENTS

What is probed into the invention is a liquid crystal device with stratified phase-separated composite and method for forming the same. Detailed descriptions of the composite composition and device structure will be provided in the following in order to make the invention thoroughly understood. Obviously, the application of the invention is not confined to specific details familiar to those who are skilled in the art. On the other hand, the common structures and fabricating steps that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In the first embodiment of the present invention, a liquid crystal device is disclosed. The liquid crystal device comprises a first substrate covered with an alignment layer and a composite material, wherein the composite material is phase-separated by a first polymerization into a polymer layer (continuous polymer layer is preferred) and a liquid crystal layer, wherein the liquid crystal layer is disposed adjacent to the alignment layer, and the polymer layer is disposed adjacent to the liquid crystal layer. Furthermore, the liquid crystal layer comprises polymer formed in situ by a second polymerization. In a preferred example of this embodiment, the mentioned liquid crystal device further comprises a second substrate located atop said polymer layer, wherein the second substrate is in planer contact with the polymer layer. Furthermore, the material of the substrates is selected from a group consisting of: polycarbonate (PC), poly ethylene terephthalate (PET), poly urethane (PU), poly-methylmethacrylate (PMMA), metallocene catalyzed cyclic olefin copolymer (mCOC), indium tin oxide (ITO) coated membrane and derivatives thereof.

In this embodiment, the composite material is formed into the layers in substantially planar form by anisotropic phase separation in the vertical direction from a solution of polymer precursor and liquid crystal. The content of liquid crystal ranges from 10% to 90% of the total weight of the solution. The liquid crystal is selected from the calamitic group consisting of nematic liquid crystal, smectic liquid crystal, cholesteric liquid crystal and (anti-)ferroelectric liquid crystal. Moreover, the first polymerization is performed by photo illumination on the covered side of the first substrate, so that the liquid crystal layer is formed adjacent to the alignment layer, and the polymer layer is formed adjacent to the liquid crystal layer when the solution is phase separated.

Afterwards, the second polymerization in the liquid crystal layer is performed by photo illumination on the uncovered side of the first substrate. The subsequently formed liquid crystal layer, which contains polymer inside, is classified into one of the three categories: polymer-dispersed liquid crystal (PDLC), polymer-network liquid crystal (PNLC) and polymer-stabilized liquid crystal (PSLC). In another preferred example of this embodiment, the mentioned polymer is cross-linked, and so does the polymer in the liquid crystal layer. These cross-linked structures are stronger and more durable than uncross-linked structures. Especially in the flexible display field, the variation of the cell gap in the bending condition is greatly reduced by the aids of cross-linked polymer structure in the thin display. In liquid crystal layer, the cross-linked polymer comprises “bridges” in horizontal direction and vertical direction, wherein the vertical bridges, connecting the polymer layer with the alignment layer, primarily provide the ability to bend or roll a display into any desired shape.

The mentioned liquid crystal device is selected from the group consisting of a display device, a spatial light modulator, a wavelength filter, a variable optical attenuator (VOA), an optical switch, a light valve, a color shutter, a lens and lens with tunable focus. Moreover, when the liquid crystal device is a display device, which is a direct addressing, a multiplexed, or an active-matrix addressing TN (twisted nematic), HAN (hybrid-aligned nematic), VA (vertical alignment), planar nematic, STN (super-TN), optically compensated bend (OCB), IPS (in plane switching) or FFS (fringe field switching) mode liquid crystal display.

In the second embodiment of the present invention, a method for fabricating a liquid crystal device with stratified phase-separated composite is disclosed. First, a solution of polymer precursor and liquid crystal is provided, wherein the content of liquid crystal ranges from 10% to 90% of the total weight of the solution. The selection of the liquid crystal is described in the first embodiment. Furthermore, the solution can further comprise cross-linking agent. Next, a substrate covered with an alignment layer is provided. The solution is then coated onto the alignment layer. Afterwards, a first polymerization of the solution is performed by a first photo illumination applied directly on said solution, so as to induce anisotropic phase separation of the solution to form a polymer layer (continuous polymer layer is preferred) and a liquid crystal layer, wherein the liquid crystal layer is formed adjacent to the alignment layer, and the polymer layer is formed adjacent to the liquid crystal layer, whereby an intermediate device is formed. Finally, a second polymerization is performed in the liquid crystal layer by a second photo illumination on the uncovered side of said substrate, so as to produce polymer fibrils in the liquid crystal layer.

In this embodiment, the temperature of the solution in the first polymerization is equal to or more than 70° C., and the intensity of the first photo illumination ranges from 0.05 mW/cm² to 0.5 mW/cm². After the first polymerization and before the second polymerization, the content of liquid crystal in the liquid crystal layer ranges from 30% to 99% of the total weight of the liquid crystal layer. According to different polymer content in the liquid crystal, the subsequently formed liquid crystal layer comprising polymer is classified into one of the group consisting of polymer-dispersed liquid crystal (PDLC), polymer-network liquid crystal (PNLC) and polymer-stabilized liquid crystal (PSLC).

In a preferred example of this embodiment, after the first polymerization, the intermediate device is cooled to be equal to or less than 35° C. Moreover, the interval between the first polymerization and the second polymerization can be equal to or more than 12 hours, and more preferred, equal to or more than 24 hours. Additionally, in the second polymerization, the temperature of the liquid crystal layer is equal to or less than 70° C., and the intensity of the second photo illumination is equal to or more than 1 mW/cm².

In the third embodiment of the present invention, a method for fabricating a liquid crystal device with stratified phase-separated composite is disclosed. First, a solution of polymer precursor and liquid crystal is provided, wherein the content of liquid crystal ranges from 10% to 90% of the total weight of the solution. The selection of the liquid crystal is described in the first embodiment. Furthermore, the solution can further comprise cross-linking agent. Next, a first substrate and a second substrate with a cell gap there between are provided, wherein the first substrate is covered with an alignment layer facing the second substrate. The solution is then introduced into the cell gap. Afterwards, a first polymerization of the solution is performed by a first photo illumination on the second substrate, so as to induce anisotropic phase separation of the solution to form a polymer layer (continuous polymer layer is preferred) and a liquid crystal layer, wherein the liquid crystal layer is formed adjacent to the alignment layer, and the polymer layer is formed adjacent to the liquid crystal layer, whereby an intermediate device is formed. Finally, a second polymerization is performed in the liquid crystal layer by a second photo illumination on the first substrate, so as to produce polymer fibrils in the liquid crystal layer.

In this embodiment, the temperature of the solution in the first polymerization is equal to or more than 70° C., and the intensity of the first photo illumination ranges from 0.05 mW/cm² to 0.5 mW/cm². After the first polymerization and before the second polymerization, the content of liquid crystal in the liquid crystal layer ranges from 30% to 99% of the total weight of the liquid crystal layer. According to different polymer content in the liquid crystal, the subsequently formed liquid crystal layer comprising polymer is classified into one of the group consisting of polymer dispersed liquid crystal (PDLC), polymer network liquid crystal (PNLC) and polymer-stabilized liquid crystal (PSLC).

In a preferred example of this embodiment, after the first polymerization, the intermediate device is cooled to be equal to or less than 35° C. Moreover, the interval between the first polymerization and the second polymerization can be equal to or more than 12 hours, and more preferred, equal to or more than 24 hours. Additionally, in the second polymerization, the temperature of the liquid crystal layer is equal to or less than 70° C., and the intensity of the second photo illumination is equal to or more than 1 mW/cm².

### EXAMPLE 1

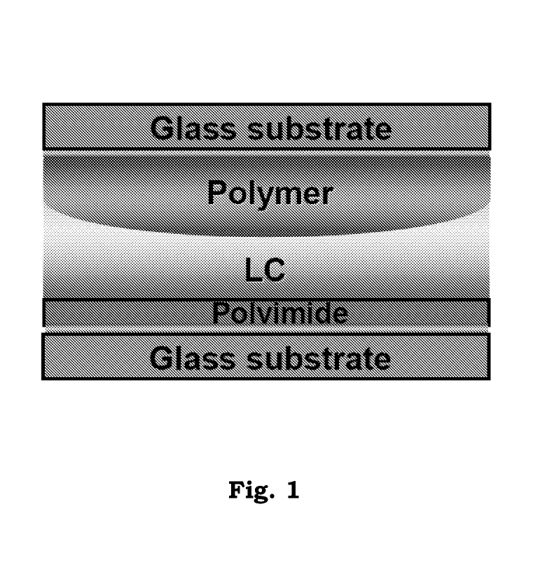

To fabricate a PSCOF for comparison, we mixed 50 wt. % poly(mercaptoesters) NOA-65 (Nordland Optical Adhesives Co.) as a photopolymerizable monomer and 50 wt. % cyano-based nematic liquid-crystal mixture E7 (Merck Co.) which exhibits a positive dielectric anisotropy. By capillary action at a temperature well above the nematic-isotropic phase transition, the blend was introduced into an empty cell consisting of a pair of transparent, electrically conductive glass substrates. Only one of the substrates was spin-coated with a thin film of polyimide as the alignment layer. The cell gap was controlled by ˜5.4-μm ball spacers. In order to obtain a smoothly layered structure, phase separation was initiated by shining the cell with a collimated beam of ultraviolet (UV) light through the untreated substrate at a very low UV intensity (˜0.1 mW/cm²). The sample was kept at 90° C. using a hot stage during the 30-min exposure. After photocuring, the cell was cooled to the room temperature slowly. Polarizing optical microscopy and scanning electron microscopy were exploited to characterize the internal configuration, confirming the double-layer structure. FIG. 1 shows the schematic of the PSCOF structure and its one-step polymerization process.

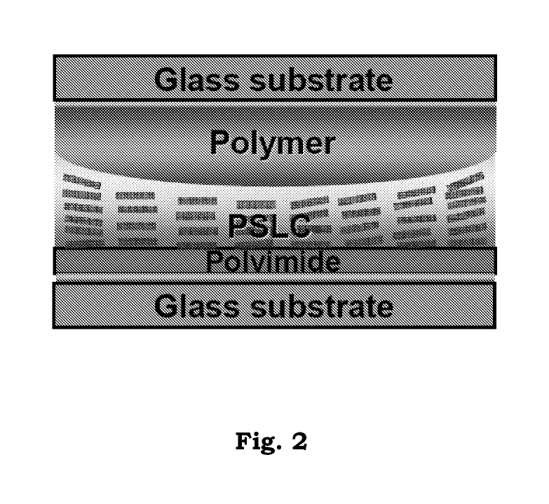

The production of our stratified polymer-stabilized liquid crystal (SPSLC), which requires an extra UV exposure at a higher intensity of 3 mW/cm² on the other side of the sample for 30 min at the room temperature, is depicted in FIG. 2. Note that the second step was performed one day after the completion of the first UV exposure. The foregoing “cooling process” and “time interval” can increase liquid crystalline order in the liquid crystal layer before the second polymerization, and promote the alignment of polymer precursor or polymeric fibrils along the aligned LC directors.

### Results

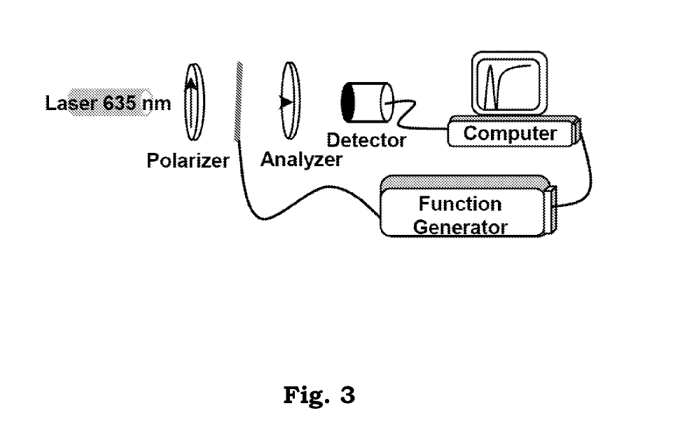

In order to understand the electro-optical properties of a LC device with the SPSLC structure, a typical setup was constructed, enabling one to acquire the transmittance as a function of the ac voltage and to obtain the associated response curve (see FIG. 3). A probe beam derived from a diode laser operating at a wavelength of 635 nm was adopted for measurements. The ac voltage used in this experiment possessed a rectangular waveform with a frequency of 1 kHz. The device sample was placed between two crossed linear polarizers.

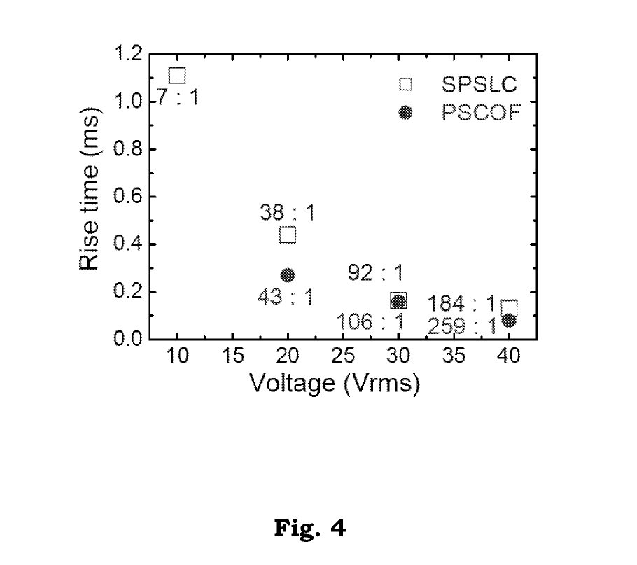

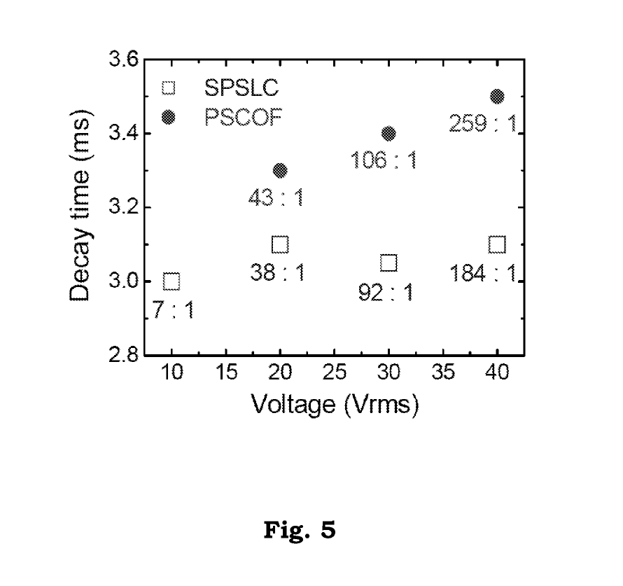

Comparisons of the electro-optical (EO) characteristics between a 5.4-μm SPSLC with a 2.7-μm-thick PSLC layer and a 5.4-μm PSCOF device with a LC thickness of 2.7 μm are illustrated in FIGS. 4 (for the turn-on response) and 5 (for the turn-off response). The rise time τₒₙ and decay time τ_{off} were measured for 90% change in total transmission as the electric field was applied and removed, respectively. The total switching time τ, defined as the sum of the rise and decay times (τₒₙ+τ_{off}), is 3-4 ms, depending on the external voltage applied. It is clear from the figures that the EO performance of the SPSLC in terms of the response speed is superior to that of the PSCOF counterpart. The obvious drawback of a SPSLC, however, is its relatively lower contrast ratio as indicated by the numerical values in FIGS. 4 and 5. It is worth mentioning that, due to the diameter of ball spacers to be ˜5.4 μm used in this study, the thickness of the (PS)LC layer formed via phase separation was still too thick for the wavelength of 635 nm of the diode-laser probe beam to exhibit a submillisecond response. In accordance with the parameters of the nematic LC E7, a planar-aligned LC layer of ˜1.5 μm in thickness, which gives a maximal phase retardation of ˜τ, can function as a half-wave plate. In addition, the driving voltage could be further lowered for a SPSLC or PSCOF cell with a thinner polymeric layer. Because of the restriction on the reduction of thickness of the LC layer with a clear boundary with polymer, ball spacers with smaller diameters are needed if one wants to demonstrate faster switching of the SPSLC device with a lower operation voltage.

In summary, we have demonstrated that nematic LC cells prepared with two-step photopolymerization-induced phase separation of LC and polymer can easily attain a polymer-PSLC bilayer structure, taking advantages of a PSCOF as well as a PSLC. The photoinduced phase separation method allows one to fine-tune the LC film thickness and the polymer content in the LC bulk. In comparison with the Paintable liquid-crystal display technology or the pixel-isolated liquid-crystal mode, this invention requires only a very simple processing procedure for manufacturing and is demonstrated to be fast-switching, exhibiting a response time of the order of 1 ms.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A liquid crystal device, comprising:
a first substrate covered with an alignment layer; and
a composite material phase-separated by a first polymerization into a polymer layer and a liquid crystal layer, wherein said liquid crystal layer is disposed adjacent to said alignment layer, and said polymer layer is disposed adjacent to said liquid crystal layer, said liquid crystal layer comprises polymer formed in situ by a second polymerization.

2. The liquid crystal device according to claim 1, further comprising a second substrate located atop said polymer layer, wherein said second substrate is in planer contact with said polymer layer.

3. The liquid crystal device according to claim 1, wherein said first polymerization is performed by photo illumination on the covered side of said first substrate.

4. The liquid crystal device according to claim 1, wherein said second polymerization is performed by photo illumination on the uncovered side of said first substrate.

5. The liquid crystal device according to claim 1, wherein said polymer layer is a continuous polymer layer.

6. The liquid crystal device according to claim 1, wherein said polymer layer is cross-linked.

7. The liquid crystal device according to claim 1, wherein said liquid crystal layer comprising polymer, which is classified into one of the group consisting of polymer dispersed liquid crystal (PDLC), polymer network liquid crystal (PNLC) and polymer-stabilized liquid crystal (PSLC).

8. The liquid crystal device according to claim 1, wherein the polymer in said liquid crystal layer is cross-linked.

9. The liquid crystal device according to claim 1, wherein said composite material is formed into said layers in substantially planar form by phase separation from a solution of polymer precursor and liquid crystal.

10. The liquid crystal device according to claim 9, wherein the content of liquid crystal ranges from 10% to 90% of the total weight of said solution.

11. The liquid crystal device according to claim 9, wherein said liquid crystal is selected from the group consisting of nematic liquid crystal, smectic liquid crystal, cholesteric liquid crystal and (anti-)ferroelectric liquid crystal.

12. The liquid crystal device according to claim 1, wherein the liquid crystal device is selected from the group consisting of a display device, a spatial light modulator, a wavelength filter, a variable optical attenuator (VOA), an optical switch, a light valve, a color shutter, a lens and lens with tunable focus.

13. The liquid crystal device according to claim 1, wherein the liquid crystal device is a display device, which is a direct addressing, a multiplexed, or an active-matrix addressing TN (twisted nematic), HAN (hybrid-aligned nematic), VA (vertical alignment), planar nematic, STN (super-TN), optically compensated bend (OCB), IPS (in plane switching) or FFS (fringe field switching) mode liquid crystal display.

14. A method for fabricating a liquid crystal device with stratified phase-separated composite, comprising the steps of:
preparing a solution of polymer precursor and liquid crystal;
providing a substrate covered with an alignment layer;
coating said solution onto said alignment layer;
performing a first polymerization of said solution by a first photo illumination applied directly on said solution, so as to induce phase separation of said solution to form a polymer layer and a liquid crystal layer, wherein said liquid crystal layer is formed adjacent to said alignment layer, said polymer layer is formed adjacent to said liquid crystal layer, whereby an intermediate device is formed; and
performing a second polymerization in said liquid crystal layer by a second photo illumination on the uncovered side of said substrate, so as to in situ fabricate polymer in said liquid crystal layer.

15. The method according to claim 14, wherein the content of liquid crystal ranges from 10% to 90% of the total weight of said solution.

16. The method according to claim 14, wherein said solution further comprises cross-linking agent.

17. The method according to claim 14, wherein said first and second photo illumination are UV illumination.

18. The method according to claim 14, wherein the intensity of said first photo illumination ranges from 0.05 mW/cm² to 0.5 mW/cm².

19. The method according to claim 14, wherein the temperature of said solution in said first polymerization is equal to or more than 70° C.

20. The method according to claim 14, further comprising a cooling process on said intermediate device, so as to decrease the temperature of said intermediate device to be equal to or less than 35° C.

21. The method according to claim 14, wherein said polymer layer is a continuous polymer layer.

22. The method according to claim 14, wherein the interval between said first polymerization and said second polymerization is equal to or more than 12 hours.

23. The method according to claim 14, wherein the interval between said first polymerization and said second polymerization is equal to or more than 24 hours.

24. The method according to claim 14, after said first polymerization and before said second polymerization, the content of liquid crystal in said liquid crystal layer ranges from 30% to 99% of the total weight of said liquid crystal layer.

25. The method according to claim 14, wherein the intensity of said second photo illumination is equal to or more than 1 mW/cm².

26. The method according to claim 14, wherein the temperature of said liquid crystal layer in said second polymerization is equal to or less than 70° C.

27. The method according to claim 14, wherein said liquid crystal layer comprising polymer, which is classified into one of the group consisting of polymer dispersed liquid crystal (PDLC), polymer network liquid crystal (PNLC) and polymer-stabilized liquid crystal (PSLC).

28. The method according to claim 14, wherein said liquid crystal is selected from the group consisting of nematic liquid crystal, smectic liquid crystal, cholesteric liquid crystal and (anti-)ferroelectric liquid crystal.

29. A method for fabricating a liquid crystal device with stratified phase-separated composite, comprising the steps of:
preparing a solution of polymer precursor and liquid crystal;
providing a first substrate and a second substrate with a cell gap there between, wherein said first substrate is covered with an alignment layer facing said second substrate;
introducing said solution into said cell gap;
performing a first polymerization of said solution by a first photo illumination on said second substrate, so as to induce phase separation of said solution to form a polymer layer and a liquid crystal layer, wherein said liquid crystal layer is formed adjacent to said alignment layer, and said polymer layer is formed adjacent to said second substrate, whereby a intermediate device is formed; and
performing a second polymerization in said liquid crystal layer by a second photo illumination on said first substrate, so as to in situ fabricate polymer in said liquid crystal layer.

30. The method according to claim 29, wherein the content of liquid crystal ranges from 10% to 90% of the total weight of said solution.

31. The method according to claim 29, wherein said solution further comprises cross-linking agent.

32. The method according to claim 29, wherein said first and second photo illumination are UV illumination.

33. The method according to claim 29, wherein the intensity of said first photo illumination ranges from 0.05 mW/cm² to 0.5 mW/cm².

34. The method according to claim 29, wherein the temperature of said solution in said first polymerization is equal to or more than 70° C.

35. The method according to claim 29, further comprising a cooling process on said intermediate device, so as to decrease the temperature of said intermediate device to be equal to or less than 35° C.

36. The method according to claim 29, wherein said polymer layer is a continuous polymer layer.

37. The method according to claim 29, wherein the interval between said first polymerization and said second polymerization is equal to or more than 12 hours.

38. The method according to claim 29, wherein the interval between said first polymerization and said second polymerization is equal to or more than 24 hours.

39. The method according to claim 29, after said first polymerization and before said second polymerization, the content of liquid crystal in said liquid crystal layer ranges from 30% to 99% of the total weight of said liquid crystal layer.

40. The method according to claim 29, wherein the intensity of said second photo illumination is equal to or more than 1 mW/cm².

41. The method according to claim 29, wherein the temperature of said liquid crystal layer in said second polymerization is equal to or less than 70° C.

42. The method according to claim 29, wherein said liquid crystal layer comprising polymer, which is classified into one of the group consisting of polymer dispersed liquid crystal (PDLC), polymer network liquid crystal (PNLC) and polymer-stabilized liquid crystal (PSLC).

43. The method according to claim 29, wherein said liquid crystal is selected from the group consisting of nematic liquid crystal, smectic liquid crystal, cholesteric liquid crystal and (anti-)ferroelectric liquid crystal.
